(19) United States
(12) Patent Application Publication
(10) Pub. No.: US 2021/0401067 A1
(43) Pub. Date: Dec. 30, 2021

(54) BIB

(71) Applicant: Weilai WANG, Wenling, Zhejiang (CN)

(72) Inventor: Weilai WANG, Wenling, Zhejiang (CN)

(21) Appl. No.: 16/963,838

(22) PCT Filed: Jan. 17, 2020
(86) PCT No.: PCT/CN2020/072594

§ 371 Date: Jul. 22, 2020

(30) Foreign Application Priority Data
Jul. 31, 2019 (CN) 201921230165.2

(51) Int. Cl. A41B 13/10; A41B 17/00

(52) U.S. Cl. CPC A41B 13/10; A41B 2400/22; A41B 17/00

(57) ABSTRACT

A bib includes a bib body and a collar formed on an upper end of the bib body, wherein the bib body includes a one-way moisture conducting layer, a water absorption layer and a water blocking and air permeating layer which are arranged in order from top to bottom, and the water absorption layer is at least one layer.

### CROSS REFERENCE TO RELATED APPLICATIONS

This application is a National Phase entry application of International Patent Application No. PCT/CN2020/072594 filed Jan. 17, 2020, which claims priority to China Patent Application No. 201921230165.2 filed on Jul. 31, 2019, the teachings of which are incorporated herein in their entireties by reference.

### FIELD OF THE INVENTION

The present disclosure relates to a field of daily necessities, and more particularly relates to a bib.

### BACKGROUND OF THE INVENTION

At present, common bibs in the market for infants, children, disabled people, patients or people with disabilities are plastic bibs, rubber bibs and cloth bibs. Plastic bibs and rubber bibs are not absorbent, and often used in eating occasions, which can effectively prevent soup or rice grains from contaminating clothes. Cloth bibs are soft and absorbent, which are especially suitable for those who may drool for long-term, such as babies. When a baby's saliva drips on the bib, the surface of the bib will get wet. Impute to the slow drying of the bib, after a period of use, the bib will cause eczema around the baby's mouth and on the baby's face.

### SUMMARY OF THE INVENTION

Accordingly, there is a need to provide a bib which can dry quickly and keep the surface dry.

The present disclosure is provided as follows.

A bib includes a bib body and a collar formed on an upper end of the bib body, wherein the bib body includes a one-way moisture conducting layer, a water absorption layer and a water blocking and air permeating layer which are arranged in order from top to bottom, and the water absorption layer is at least one layer.

Preferably, the one-way moisture conducting layer is a partial waterproof and permeable layer, the partial waterproof and permeable layer comprises a base fabric and a waterproof auxiliary layer printed on the base fabric, the waterproof auxiliary layer is spaced distributed on the upper surface of the base fabric, and the base fabric between the adjacent waterproof auxiliary layers is exposed.

Preferably, the one-way moisture conducting layer is made by interweaving polypropylene yarn and polyester.

Preferably, the surface of the one-way moisture conducting layer is formed of heteromorphic fiber or microfiber.

Preferably, the water blocking and air permeating layer is a waterproof knitted fabric layer or a waterproof cotton cloth layer.

Preferably, the water absorption layer is a hydrophilic gauze layer or a bamboo fiber batt layer or a hydrophilic bat layer.

Preferably, the bib further includes a bottom layer placed below the water blocking and air permeating layer, wherein the bottom layer is a skin friendly fabric layer.

Preferably, the bib further includes a binding configured to seal the outer edge of the one-way moisture conducting layer, the water absorption layer, the water blocking and air permeating layer and the bottom layer, and to seal the inner edge the collar.

Preferably, the bib further includes a binding configured to seal the outer edge of the one-way moisture conducting layer, the water absorption layer and the water blocking and air permeating layer, and to seal the inner edge the collar.

Preferably, the upper end of the bib body is separated, and is able to be connected by a connector.

Compared with the common bibs, the present disclosure has the following advantages:

1. The one-way moisture conducting layer as the first layer of the present disclosure guide the liquid into the next layer quickly by using the one-way moisture conducting property of the fabric, and the one-way moisture conducting function increases the contact dryness of the surface, therefore its drying speed is fast. The water absorption layer as the second layer has a good water absorption capacity and increases the water absorption, as the water absorption layer is close to the one-way moisture conducting layer and has a good water absorption capacity, the water absorption layer can quickly absorb the liquid introduced from the one-way moisture conducting layer, helping the one-way moisture conducting layer to keep dry and accelerate the drying speed of the one-way moisture conducting layer. The water blocking and air permeating layer as the third layer is used to prevent water molecules from permeating into the below clothes and wetting the below clothes, and maintain the air permeability of the bib.

2. The fourth layer of the present disclosure is the bottom layer of the bib made of soft skin friendly fabric, which is used to prevent the skin or clothes from contacting the water blocking and air permeating layer.

3. The present disclosure is quick drying, waterproof, air permeating, and dry to touch, which can effectively relieve eczema of infants.

### BRIEF DESCRIPTION OF THE DRAWINGS

The following drawings of the present invention are used to understand the invention as a part of it. The drawings show a embodiment and the description of the embodiment, so as to explain the principle of the invention, in which:

FIG. 1 shows the perspective view of the bib of the present disclosure;

FIG. 2 shows the partial diagram of the bib of the present disclosure; and

FIG. 3 shows the cutaway view of the bib of the present disclosure.

In the figures:

1—bib body; 2—collar, 3—one-way moisture conducting layer, 4—water absorption layer; 5—water blocking and air permeating layer; 6—base fabric; 7—waterproof auxiliary layer; 8—bottom layer, 9—binding; 10—snap button.

### DETAILED DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the size and the relative dimension of layers and areas may be exaggerated for clear. Like numbers refer to like elements throughout.

It should be understood that if a component or a layer is described as “on”, “adjacent to”, “connected to” or “coupled to” another component or layer, it may be directly configured on, adjacent to, connected to or coupled to the other component, or there may be a mediate component or a mediate layer. Rather, if a component or a layer is described as “directly on” , “directly adjacent to” , “directly connected to” or “directly coupled to” another component or layer, mediate component or mediate layer does not exist.

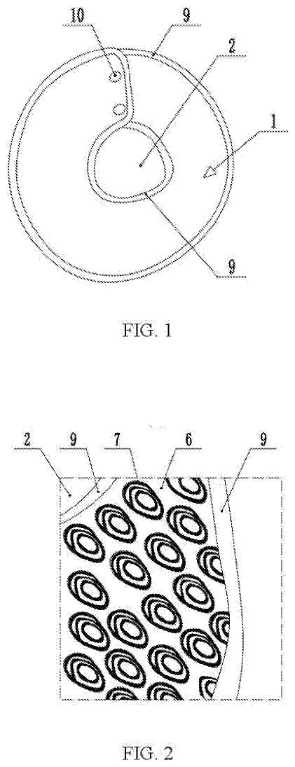

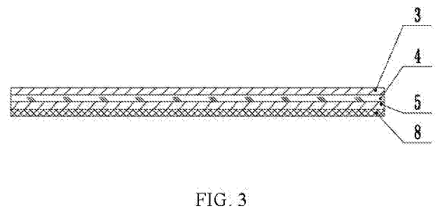

As shown in FIG. 1-3, the present disclosure provides a bib includes a bib body 1 and a collar 2 formed on an upper end of the bib body 1, the upper end of the bib body 1 is determined according to the direction of using the bib. The bib body 1 includes a one-way moisture conducting layer 3, a water absorption layer 4 and a water blocking and air permeating layer 5 which are arranged in order from top to bottom, and the water absorption layer 4 is at least one layer.

The one-way moisture conducting layer of the present disclosure has a composite double-layer structure. As the hydrophilicity and hydrophobicity of the inner layer and outer layer of the fabric are different, specifically, most area of the outer layer is hydrophobic while the inner layer is hydrophilic. When liquid contacts the outer layer, it will transfer from a small hydrophilic area of the outer layer to the hydrophilic inner layer of the fabric. Therefore, there are two conditions for the one-way moisture conducting layer: (a) the outer layer of the fabric has good capillary effect, and (b) the inner layer of the fabric has good diffusion effect on water.

In the embodiment, the one-way moisture conducting layer 3 is a partial waterproof and permeable layer, the partial waterproof and permeable layer includes a base fabric 6 and a waterproof auxiliary layer 7 printed on the base fabric 6. The waterproof auxiliary layer 7 is spaced distributed on the upper surface of the base fabric 6, and the base fabric 6 between the adjacent waterproof auxiliary layers 7 is exposed. The base fabric 6 is generally made of cotton, and the specific lines or patterns of the waterproof auxiliary layer 7 can be designed according to actual situations. As shown in FIG. 2, the basic fabric 6 is covered with circles, the black filling part is the waterproof agent layer 7, while the other part is the base fabric 6.

The shape of the waterproof agent layer 7 can also be crisscross curves or straight lines with a certain width, additionally, the shape of the waterproof agent layer 7 may be a hollow cartoon pattern or else.

The partial waterproof and permeable layer 3 is able to Guide the liquid to the next layer quickly through the partial hydrophilicity of the fabric (as the exposed base fabric 6 is hydrophilic), and the partial hydrophobicity increases its surface contact dryness (as the waterproof auxiliary layer 7 is hydrophobic). The small thickness (0.1-1.5 mm) of the partial waterproof and permeable layer 3 can also accelerate the drying speed of the fabric to achieve quick drying effect.

The waterproof auxiliary layer 7 of the present disclosure is recessively printed, in normal state, the waterproof auxiliary layer 7 will not appear. Therefore, in order to increase the beauty of the bib, patterns can also be printed on the surface of the partial waterproof and permeable layer 3.

In another embodiment, the one-way moisture conducting layer 3 is made by interweaving polypropylene yarn and polyester. The moisture will enter the polyester surface from the polypropylene surface, but will not enter the polypropylene surface from the polyester surface, which can achieve the effect of one-way moisture conduction.

In another embodiment, the surface of the one-way moisture conducting layer is formed of heteromorphic fiber or microfiber. According to the principle of capillary differential effect of the heteromorphic chemical fiber, the moisture absorption and moisture conductivity of fabrics can be changed by spinning or other finishing, such as strong twist yam. In addition, the yarn can be treated with hydrophilic finish or water repellent finish before weaving, so as to change its performance. The finer the fiber is, or the more complex the cross-section shape of the fiber is, the more grooves and micropores are on the surface, that is to say, the larger the heteromorphic degree of the fiber is, the more capillary tubes are formed, and the stronger the moisture conductivity of the fabric can be.

The water absorption layer 4 of the present disclosure is a hydrophilic gauze layer or a bamboo fiber batt layer or a hydrophilic batt layer. The bib may include one or more than one water absorption layer. As the water absorption layer 4 has a good water absorption capacity which increases the water absorption, and the water absorption layer 4 is close to the one-way moisture conducting layer 3, the water absorption layer 4 can quickly absorb the liquid introduced from the one-way moisture conducting layer 3, helping the one-way moisture conducting layer 3 to keep dry and accelerate the drying speed of the one-way moisture conducting layer 3.

The water blocking and air permeating layer 5 of the present disclosure is a fabric layer after waterproof treatment, or a water repellent polymer layer, which can prevent water molecules from continuing to penetrate and then wet the clothes, while maintaining the air permeability.

Preferably, in order to prevent the skin or clothing from contacting the water blocking and air permeating layer 5, a bottom layer 8 is placed below the water blocking and air permeating layer 5. The bottom layer 8 is a skin friendly fabric layer, such as a cotton layer.

Preferably, the bib further includes a binding 9 configured to seal the outer edge of the one-way moisture conducting layer 3, the water absorption layer 4, the water blocking and air permeating layer 5 and the bottom layer 8, and to seal the inner edge the collar 2.

In another embodiment, the bib without the bottom layer further includes a binding 9 configured to seal the outer edge of the one-way moisture conducting layer 3, the water absorption layer 4 and the water blocking and air permeating layer 5, and to seal the inner edge the collar 2.

The binding 9 is generally made of cotton cloth. When using the bib, the binding 9, which is located at the collar 2 places, directly contacts with the skin is able to improve the comfort of use.

The upper end of the bib body 1 is separated, and is able to be connected by a connector such as a snap button 10 or a hook-and-loop fastener. The connector can be disassembled and connected quickly, and is easy to use.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A bib comprising a bib body and a collar formed on an upper end of the bib body, wherein the bib body comprises a one-way moisture conducting layer, a water absorption layer and a water blocking and air permeating layer which are arranged in order from top to bottom, and the water absorption layer is at least one layer.

2. The bib according to claim 1, wherein the one-way moisture conducting layer is a partial waterproof and permeable layer, the partial waterproof and permeable layer comprises a base fabric and a waterproof auxiliary layer printed on the base fabric, the waterproof auxiliary layer is spaced distributed on the upper surface of the base fabric, and the base fabric between the adjacent waterproof auxiliary layers is exposed.

3. The bib according to claim 1, wherein the one-way moisture conducting layer is made by interweaving polypropylene yarn and polyester.

4. The bib according to claim 1, wherein the surface of the one-way moisture conducting layer is formed of heteromorphic fiber or microfiber.

5. The bib according to claim 1, wherein the water blocking and air permeating layer is a waterproof knitted fabric layer or a waterproof cotton cloth layer.

6. The bib according to claim 1, wherein the water absorption layer is a hydrophilic gauze layer or a bamboo fiber batt layer or a hydrophilic bat layer.

7. The bib according to claim 1, further comprising a bottom layer placed below the water blocking and air permeating layer, wherein the bottom layer is a skin friendly fabric layer.

8. The bib according to claim 7, further comprising a binding configured to seal the outer edge of the one-way moisture conducting layer, the water absorption layer, the water blocking and air permeating layer and the bottom layer, and to seal the inner edge the collar.

9. The bib according to claim 1, wherein further comprising a binding configured to seal the outer edge of the one-way moisture conducting layer, the water absorption layer and the water blocking and air permeating layer, and to seal the inner edge the collar.

10. The bib according to claim 1, wherein the upper end of the bib body is separated, and is able to be connected by a connector.
